(19) United States
(12) Patent Application Publication
(10) Pub. No.: US 2024/0127306 A1
(43) Pub. Date: Apr. 18, 2024

(54) GENERATION AND MANAGEMENT OF DATA QUALITY SCORES USING MULTIMODAL MACHINE LEARNING

(71) Applicant: Verishop Inc., Santa Monica, CA (US)

(72) Inventors: Edward Kim, Santa Monica, CA (US); Talia Koss, New York, NY (US); Reza Shahbazi, Irvine, CA (US); Andrew Vayanis, Potomac, MD (US); Rong Yan, Santa Monica, CA (US)

(21) Appl. No.: 18/244,901

(22) Filed: Sep. 11, 2023

Related U.S. Application Data
(60) Provisional application No. 63/415,569, filed on Oct. 12, 2022.

(51) Int. Cl. G06Q 30/0601; G06Q 30/0201

(52) U.S. Cl. CPC G06Q 30/0623; G06Q 30/0201

(57) ABSTRACT

Various examples described herein support or provide for data ingesting, aggregating, and organizing in one centralized location; enhancing data through data enrichment and artificial intelligence and machine learning automation into tailored recommendations; and distributing and integrating data into channels that help facilitating data exchange based on individual needs and/or third-party solutions.

### CLAIM OF PRIORITY

This application claims the benefit of priority under 35 U.S.C. § 119(e) to U.S. Patent Application Ser. No. 63/415,569, filed on Oct. 12, 2022, which is incorporated by reference herein in its entirety.

### TECHNICAL FIELD

The present disclosure generally relates to managing data across a variety of data sources. Particularly, various examples described herein provide for systems, methods, techniques, instruction sequences, and devices that use multimodal machine learning technology to facilitate data consolidation, integration, enhancement, and distribution.

### BACKGROUND

Due to various data restrictions, data management systems face challenges when consolidating data across a variety of sources. Challenges also arise when it comes to efficiently enhancing and distributing data that enables easy data integration with third-party solutions.

### BRIEF DESCRIPTION OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some examples are illustrated by way of examples, and not limitations, in the accompanying figures.

FIG. 1 is a block diagram showing an example data system that includes a data management system in a multimodal artificial intelligence system, according to various examples.

FIG. 2 is a block diagram illustrating an example data management systems in a multimodal artificial intelligence system, according to various examples.

FIG. 3 is a block diagram illustrating data flow within an example data management system in a multimodal artificial intelligence system during operation, according to various examples.

FIG. 4 is a flowchart illustrating an example method for generating and managing data quality scores, according to various examples.

FIG. 5 is a flowchart illustrating an example method for generating and managing data quality scores, according to various examples.

FIGS. 6A and 6B are block diagrams illustrating an example data management system in a multi modal artificial intelligence system, according to various examples.

FIG. 7 is a block diagram illustrating a representative software architecture, which may be used in conjunction with various hardware architectures herein described, according to various examples.

FIG. 8 is a block diagram illustrating components of a machine able to read instructions from a machine storage medium and perform any one or more of the methodologies discussed herein according to various examples.

### DETAILED DESCRIPTION

Various examples described herein address various deficiencies of conventional art. Compared to a uni-modal architecture that is capable of processing a single type of mode (as an example of a modality)), a data management system in the multimodal architecture (e.g., a multimodal artificial intelligence system), as described herein, adds a greater level of data complexity by analyzing multiple modes (or modalities) as data inputs using artificial intelligence (AI) and machine learning (NIL) technologies. Such multimodal processing and analytics capabilities provide the system with flexible integration across various data sources and/or destinations and enable low-code turnkey solutions for new vendor services and/or marketing and selling opportunities.

In various examples, a multimodal architecture for data using machine learning frameworks includes a data management system that provides for various functions as described herein. Example functions include data aggregation and organization in one centralized location; enhancing brands' data through data enrichment and AI/NIL automation into tailored recommendations and distributing and integrating brands' data into channels that help facilitate transactions based on individual needs.

Specifically, in various examples, the data management system aggregates data from various data sources, including data provided by third-party data providers and web-based data sources, such as e-Commerce platforms, social media platforms, marketing channels, etc. In various examples, users may provide data via uploading one or more comma-separated values in files (e.g., CSV files) that include item data (e.g., product descriptions). The aggregated data may include texts, images, videos, audio, and metadata. The data management system uses ML models to generate taxonomies (examples of which may include item taxonomies, product taxonomies, brand item taxonomies, or graphs) that are specific to the product/service providers (e.g., brands), and generates customized titles, descriptions, and images for items (e.g., products) based on the generated taxonomies.

In various examples, the data management system may generate one or more data quality scores for one or more items (e.g., the first item) of a brand in order to provide merchant product insights. Data quality scores may be used to indicate the completeness of item data and can also be used to anticipate a level of user engagement. Specifically, the data management system may determine the degrees of completeness of one or more items based on the item data. The data management system may identify customer engagement data (as an example engagement data) associated with the same or similar items (e.g., the second item) and generate one or more data quality scores based on the degrees of completeness of one or more items (e.g., the first item) and/or the customer engagement data. In various examples, the customer engagement data may be associated with items of other brands and/or items dissimilar to the one or more items e.g., the first item), based on which the one or more data quality scores are generated.

As used herein, a machine learning (NIL) model can comprise any predictive model that is generated based on (or that is trained on) training data. Once generated/trained, a machine learning model can receive one or more inputs (e.g., one or more tags), extract one or more features, and generate an output for the inputs based on the model's training. Different types of machine learning models can include, without limitation, ones trained using supervised learning, unsupervised learning, reinforcement learning, or deep learning (e.g., complex neural networks).

In various examples, engagement data can be generated using cursor-tracking and/or website-tracking technologies that track user interactions with a specific data resource (e.g., a webpage, such as a product description page). Specifically, a tracking tool can be used to track, collect, and collate user data, including the location of the mouse cursor (e.g., in terms of pixels), time stamps, any time the mouse cursor hovers on a link of interest, mouse clicks, time spent in areas of interest, and duration of hovers, etc. In various examples, a tracking tool described herein can be a third-party application, such as a cursor tracking application or a website tracking application. The data management system can analyze such user data to determine, for example, which field and/or part of a webpage (e.g., product description page) a particular user was mostly interested in and helped drive a conversion (e.g., a purchase of a product or a service). Engagement data can be generated based on data collected by the cursor-tracking tool and generated engagement data for a particular user, a type of item, and/or a specific brand.

Reference will now be made in detail to examples, examples of which are illustrated in the appended drawings. The present disclosure may, however, be embodied in many different forms and should not be construed as being limited to the examples set forth herein.

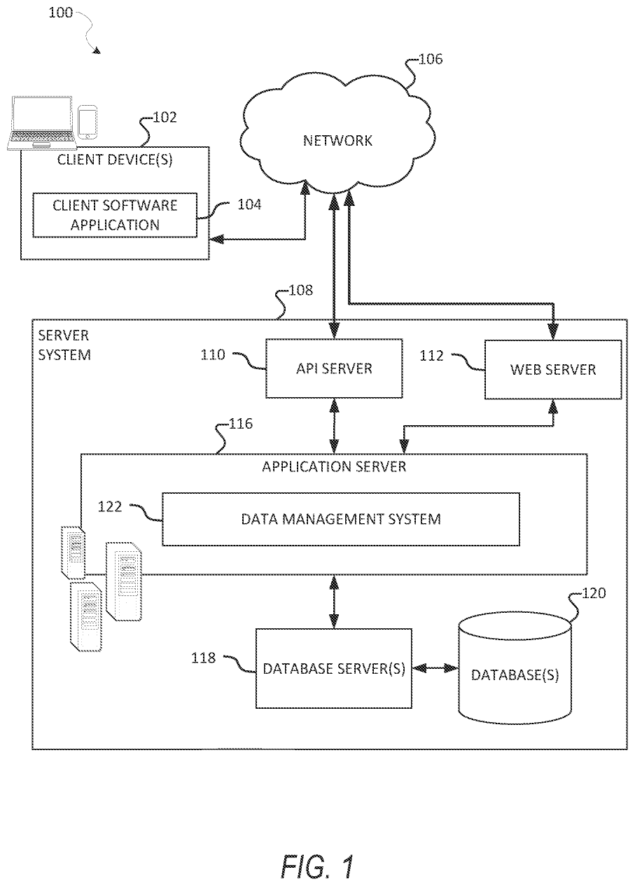

FIG. 1 is a block diagram showing an example data system that includes a data management system in a multimodal artificial intelligence system (hereafter, the data management system 122, or system 122), according to various examples. As shown, the data system 100 includes one or more client devices 102, a server system 108, and a network 106 (e.g., including Internet, wide-area-network (WAN), local-area-network (LAN), wireless network, etc.) that communicatively couples them together. Each client device 102 can host a number of applications, including a client software application 104. The client software application 104 can communicate data with the server system 108 via a network 106. Accordingly, the client software application 104 can communicate and exchange data with the server system 108 via network 106.

The server system 108 provides server-side functionality via the network 106 to the client software application 104. While certain functions of the data system 100 are described herein as being performed by the data management system 122 on the server system 108, it will be appreciated that the location of certain functionality within the server system 108 is a design choice. For example, it may be technically preferable to initially deploy certain technology and functionality within the server system 108, but to later migrate this technology and functionality to the client software application 104 where the client device 102 provides various operations as described herein.

The server system 108 supports various services and operations that are provided to the client software application 104 by the data management system 122. Such operations include transmitting data from the data management system 122 to the client software application 104, receiving data from the client software application 104 to the system 122, and the system 122 processing data generated by the client software application 104. Data exchanges within the data system 100 may be invoked and controlled through operations of software component environments available via one or more endpoints, or functions available via one or more user interfaces of the client software application 104, which may include web-based user interfaces provided by the server system 108 for presentation at the client device 102.

With respect to the server system 108, each of an Application Program Interface (API) server 110 and a web server 112 is coupled to an application server 116, which hosts the data management system 122. The application server 116 is communicatively coupled to a database server 118, which facilitates access to a database 120 that stores data associated with the application server 116, including data that may be generated or used by the data management system 122.

The API server 110 receives and transmits data (e.g., API calls, commands, requests, responses, and authentication data) between the client device 102 and the application server 116. Specifically, the API server 110 provides a set of interfaces (e.g., routines and protocols) that can be called or queried by the client software application 104 in order to invoke the functionality of the application server 116. The API server 110 exposes various functions supported by the application server 116 including, without limitation: user registration; login functionality; data object operations (e.g., generating, storing, retrieving, encrypting, decrypting, transferring, access rights, licensing, etc.); and user communications.

Through one or more web-based interfaces (e.g., web-based user interfaces), the web server 112 can support various functionality of the data management system 122 of the application server 116.

The application server 116 hosts a number of applications and subsystems, including the data management system 122, which supports various functions and services with respect to various examples described herein.

The application server 116 is communicatively coupled to a database server 118, which facilitates access to database 120 that stores data associated with the data management system 122.

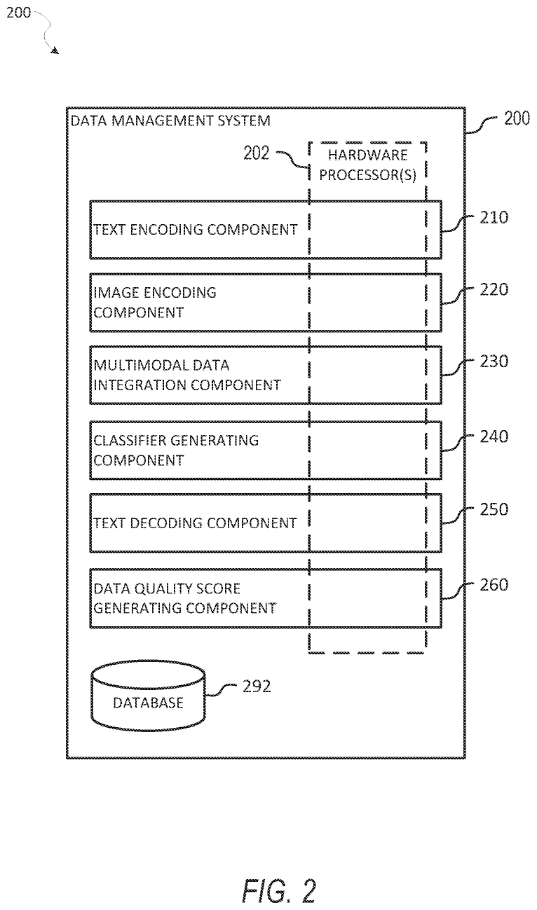

FIG. 2 is a block diagram illustrating an example data management system 200 in a multimodal artificial intelligence system, according to various examples. For some examples, the data management system 200 represents an example of the data system 100 described with respect to FIG. 1. As shown, the data management system 200 comprises a text encoding component 210, an image encoding component 220, a multimodal data integration component 230, a classifier generating component 240, a text decoding component 250, a data quality score generating component 260, and a database 292. According to various examples, one or more of the text encoding component 210, the image encoding component 220, the multimodal data integration component 230, the classifier generating component 240, the text decoding component 250, the data quality score generating component 260 are implemented by one or more hardware processors 202.

The text encoding component 210 is configured to extract texts from aggregated data from various data sources and generate taxonomies (e.g., item taxonomies, product taxonomies, brand item taxonomies, or graphs) based on the aggregated data. The text encoding component 210 may include one or more ML models, including without limitation, transformer-based ML models.

The image encoding component 220 is configured to extract images from aggregated data from various data sources and generate taxonomies (examples of which may include item taxonomies, product taxonomies, brand item taxonomies, or graphs) based on the aggregated data. The image encoding component 220 may include one or more ML models, including without limitation, Convolutional Neural Network (CNN) based ML models.

The multimodal data integration component 230 is configured to integrate the taxonomies across all product/service providers (e.g., brands), and generate taxonomies that are specific to particular product/service providers. The multimodal data integration component 230 may include one or more ML models, including without limitation, transformer-based ML models.

The classifier generating component 240 is configured to identify fields associated with items on webpages, determine attributes (e.g., first attribute) of the items based on content data and metadata associated with the fields, and match the determined attributes with attributes (e.g., second attribute) in an existing taxonomy. Based on the matching, the classifier generating component 240 is configured to generate classifiers (for all categorical fields) that represent categories of the item.

In various examples, the classifier generating component 240 is configured to generate classifications (e.g., taxonomies) inferred from classifier(s) that represents the categories of the item(s).

The text decoding component 250 is configured to generate item titles, descriptions, and images for the same or similar items based on the taxonomies as described herein.

The data quality score generating component 260 is configured to generate one or more data quality scores for one or more items (e.g., the first item) of a brand in order to provide the merchant of the brand with product insights. Specifically, the data quality score generating component 260 is configured to determine the degrees of completeness of one or more items based on the item data. The data quality score generating component 260 is further configured to identify customer engagement data (or engagement data) associated with the same or similar items (e.g., the second item) and generate one or more data quality scores based on the degrees of completeness of one or more items (e.g., the first item) and the customer engagement data. In various examples, the customer engagement data may be associated with items of other brands and/or items dissimilar to the one or more items (e.g., the first item), based on which the one or more data quality scores are generated.

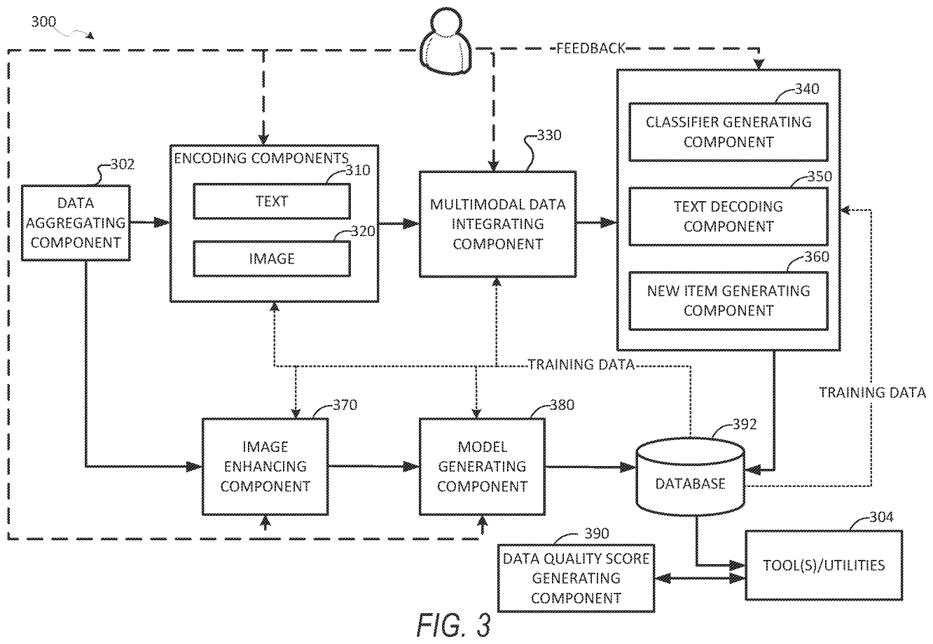

FIG. 3 is a block diagram illustrating data flow within an example data management system 300 in a multimodal artificial intelligence system during operation, according to various examples. As shown, the data management system 300 comprises a data aggregating component 302, a text encoding component 310, an image encoding component 320, a multimodal data integration component 330, a classifier generating component 340, a text decoding component 350, a new item generating and managing component 360, an image enhancing component 370, a model generating component 380, a data quality score generating component 390, and a database 392. In various examples, the text encoding component 310, the image encoding component 320, the multimodal data integration component 330, the classifier generating component 340, the text decoding component 350, the new item generating and managing component 360, the image enhancing component 370, and the model generating component 380 are respectively similar to the text encoding component 210, the image encoding component 220, the multimodal data integration component 230, the classifier generating component 240, the text decoding component 250, the new item generating and managing component 260, the image enhancing component 270, the model generating component 280, and the data quality score generating component 290 of the data management system 200 of FIG. 2. Additionally, each of the data aggregating component 302, the text encoding component 310, the image encoding component 320, the multi modal data integration component 330, the classifier generating component 340, the text decoding component 350, the new item generating and managing component 360, the image enhancing component 370, the model generating component 380, and the data quality score generating component 390 can comprise a machine learning (ML) model that enables or facilitates operation as described herein.

During operation, the text encoding component 310 extracts texts from aggregated data from various data sources and generate taxonomies (examples of which may include item taxonomies, product taxonomies, brand item taxonomies, or graphs) based on the aggregated data. The text encoding component 310 may include one or more transformer-based MIL models.

The image encoding component 320 extracts images from aggregated data from various data sources and generates taxonomies (examples of which may include item taxonomies, product taxonomies, brand item taxonomies, or graphs) based on the aggregated data. The image encoding component 320 may include one or more Convolutional Neural Network (CNN) based ML models.

The multimodal data integration component 330 integrates the taxonomies across all product/service providers (e.g., brands), and generates taxonomies that are specific to particular product/service providers. The multimodal data integration component 330 may include one or more transformer-based ML models.

The classifier generating component 340 identifies fields (e.g., text fields, image fields) associated with items (e.g., products) on webpages, determines attributes (e.g., first attribute) of the items based on content data and metadata associated with the fields, and matches the determined attributes with attributes (e.g., second attribute) in an existing taxonomy. Based on the matching, the classifier generating component 340 generates classifiers (for all categorical fields) that represent categories of the item.

The text decoding component 350 generates item titles (e.g., product title), descriptions (e.g., product description), and images for the same or similar items based on the taxonomies as described herein.

The new item generating and managing component 360 generates representations of new items (e.g., Scandinavian-styled furniture) based on the taxonomies as described herein. The new items are distinguishable from the items (e.g., existing furniture) currently offered by a brand. The new item generating and managing component 360 generates test engagements based on the representations of the new items. A test engagement may be a UI element that displays an imagery representation of the new item (e.g., Scandinavian-styled furniture illustrated in an image) and invites users to provide comments via text comments or clicks (e.g., like or dislike). Engagement data (e.g., in the form of reports, for example) may be generated based on the comments, be used for downstream analysis (via tools/utilities 304), and/or be provided to the brand itself for evaluation.

The image enhancing component 370 enhances images. For example, image enhancement may include applying one or more filters to images and removing the image backgrounds from images, etc.

The model generating component 380 generates human models (or mannequins) based on images obtained from various data sources. Specifically, the model generating component 380 determines human characteristics that correspond to a specific geographical location and uses ML models to apply the geographical-specific human characteristics to an existing image in order to alter the appearance of the human model in the image.

The data quality score generating component 390 is configured to generate one or more data quality scores for one or more items (e.g., the first item) of a brand in order to provide the merchant of the brand with product insights. Specifically, the data quality score generating component 390 is configured to determine the degrees of completeness of one or more items based on the item data. The data quality score generating component 390 is further configured to identify customer engagement data (or engagement data) associated with the same or similar items (e.g., the second item) and generate one or more data quality scores based on the degrees of completeness of one or more items (e.g., the first item) and the customer engagement data. In various examples, the customer engagement data may be associated with items of other brands and/or items dissimilar to the one or more items (e.g., the first item), based on which the one or more data quality scores are generated.

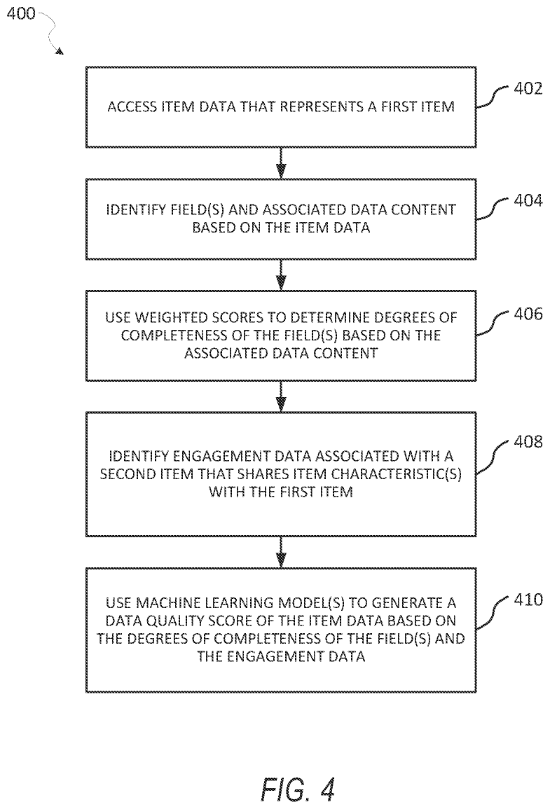

FIG. 4 is a flowchart illustrating an example method 400 for generating and managing data quality scores, according to various examples. It will be understood that methods described herein may be performed by a machine in accordance with some examples. For example, method 400 can be performed by the data management system 122 described with respect to FIG. 1, the data management system 200 described with respect to FIG. 2, the data management system described with respect to FIG. 3, or individual components thereof. An operation of various methods described herein may be performed by one or more hardware processors (e.g., central processing; units or graphics processing units) of a computing device e.g., a desktop, server, laptop, mobile phone, tablet, etc.), which may be part of a computing system based on a cloud architecture. Example methods described herein may also be implemented in the form of executable instructions stored on a machine-readable medium or in the form of electronic circuitry. For instance, the operations of method 400 may be represented by executable instructions that, when executed by a processor of a computing device, cause the computing device to perform method 400. Depending on the example, an operation of an example method described herein may be repeated in different ways or involve intervening operations not shown. Though the operations of example methods may be depicted and described in a certain order, the order in which the operations are performed may vary among examples, including performing certain operations in parallel.

At operation 402, a processor accesses item data that represents an item (e.g., the first item). Item data may be provided by one or more merchants and be accessed from one or more databases associated with the data management system.

At operation 404, a processor identifies a plurality of fields and associated data content based on the item data. The plurality of fields may include one or more of a text field, a video field, and an image field. The text field may include at least one of a color field, a title field, and a product description field.

At operation 406, a processor uses weighted scores (also referred to as weight scores or weights) to determine degrees of completeness of the plurality of fields based on the associated data content. For example, if a field is associated with (e.g., filled out) with complete data content (e.g., information), the field is assigned a higher weighted score than a field that is associated with incomplete or no data content. Some fields can be determined (and labeled) as required fields, and other fields can be determined (and labeled) as optional fields. In various examples, a complete required field can be assigned a higher weight score than a complete optional field. In various examples, the plurality of fields and the associated data content are identified using a natural language processing algorithm.

For example, a title field could be given a weighted score of 1.0, a required description field given a weighted score of 0.8, a required color field given a weighted score of 0.5, and an optional size field given a weighted score of 0.2. If the title, description, and color fields were filled out with relevant data, but the size field was left blank, the completeness scores would be calculated as:
Title (weight 1.0): 1.0*1.0=1.0 Description (weight 0.8): 0.8*1.0=0.8 Color (weight 0.5): 0.5*1.0=0.5 Size (weight 0.2): 0.2*0=0
Total completeness score=1.0+0.8+0.5=+0 2.3

The total completeness score of 2.3 for this item listing would then be normalized to a data quality score between 0 to 1, such as 0.575, based on the total possible completeness score of 4.0 for all fields.

By using predetermined weights for each field based on its importance and whether it is required or optional, method 400 can generate data quality scores that accurately reflect the completeness and quality of information provided for each item listing. The natural language processing algorithm may analyze the data associated with each field to determine if it contains relevant information for the specific type of item and field before assigning a completeness score.

At operation 408, a processor identifies engagement data associated with a second item that shares an item characteristic with the first item. Example item characteristics can include the size, shape, weight, color, quality, and price of an item. In various examples, the engagement data may include one or more engagement metrics that indicate degrees of user interactions with one or more fields included in one or more item listings of the second item.

In various examples, engagement data may be associated with a plurality of items of the same brand as the first item.

At operation 410, a processor uses a machine learning model to generate a data quality score of the item data based on the degrees of completeness of the plurality of fields and the engagement data.

In some examples, the machine learning model is used to generate the data quality scores from the completeness scores of the fields, and the engagement data is a regression model trained on historical data. The model takes the calculated completeness scores for all the fields of an item listing and the engagement metrics for that listing type as input. It then outputs a predicted data quality score between 0 to 1 for the listing.

The model may be trained on a large data set of examples of item listings with known data quality scores and engagement metrics. During training, the model learns the relationship between field completeness, engagement, and the actual data quality scores: The model can then apply what it has learned to new item listings to predict their data quality scores. For example, a random forest regression model may be used to create an ensemble of decision trees that each vote on the predicted data quality score. The votes are then averaged to give the final prediction. By using a machine learning model trained on historical data, the system can accurately predict data quality scores for new item listings based on the completeness of their fields and expected user engagement. The model accounts for complex relationships in the data that would be difficult to determine using a rules-based approach alone: In some examples, a neural network could be used instead of a random forest regression model. For example, a fully connected feedforward neural network with three hidden layers of over nodes each may be used. The neural network learns a complex relationship between the input features and target data quality scores during training which can provide accurate predictions.

The machine learning model may need to be retrained periodically on new data to keep its predictions accurate. For example, the model could be retrained:
Monthly using all new item listings from the past month;
Weekly using listings with low data quality scores or low engagement to improve predictions for those types of listings; or
When new feature types are added (e.g., video data) to teach the model how to incorporate them.

Retraining the model on a regular basis with the most up-to-date data helps ensure its predictions remain accurate as new data becomes available and relationships in the data change over time.

Though not illustrated, the method 400 can include an operation where a graphical user interface for managing data can be displayed (or caused to be displayed) by the hardware processor. For instance, the operation can cause a computing device to display the graphical user interface for managing data across a variety of data sources. This operation for displaying the graphical user interface can be separate from operations 402 through 410 or, alternatively, form part of one or more of operations 402 through 410.

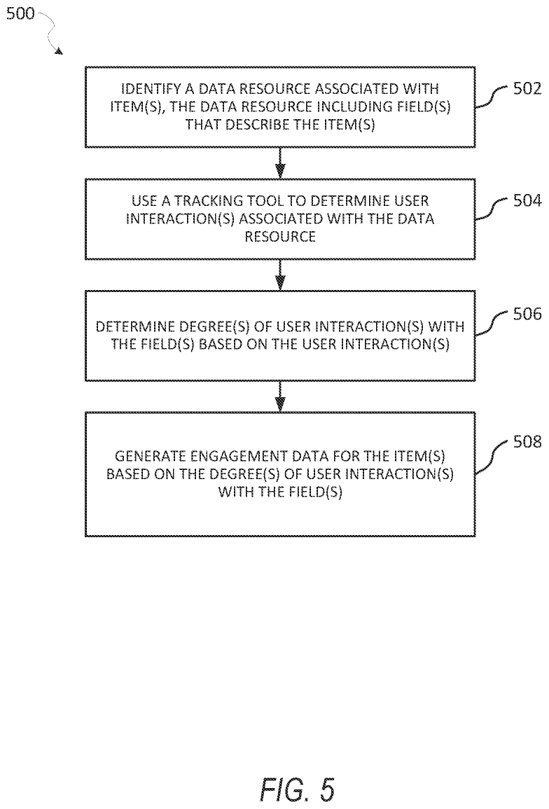

FIG. 5 is a flowchart illustrating an example method 500 for generating and managing data quality scores, according to various examples. It will be understood that methods described herein may be performed by a machine in accordance with some examples. For example, method 500 can be performed by the data management system 122 described with respect to FIG. 1, the data management system 200 described with respect to FIG. 2, the data management system described with respect to FIG. 3, or individual components thereof. An operation of various methods described herein may be performed by one or more hardware processors (e.g., central processing units or graphics processing units) of a computing device (e.g., a desktop, server, laptop, mobile phone, tablet, etc.), which may be part of a computing system based on a cloud architecture. Example methods described herein may also be implemented in the form of executable instructions stored on a machine-readable medium or in the form of electronic circuitry. For instance, the operations of method 500 may be represented by executable instructions that, when executed by a processor of a computing device, cause the computing device to perform method 500. Depending on the example, an operation of an example method described herein may be repeated in different ways or involve intervening operations not shown. Though the operations of example methods may be depicted and described in a certain order, the order in which the operations are performed may vary among examples, including performing certain operations in parallel.

At operation 502, a processor identifies a data resource (e.g., a web-based data resource, such as a product description page) associated with an item. The data resource can include one or more fields (e.g., a text field, a video field, an image field, a color field, a title field, or a product description field) that describe the item.

At operation 504, a processor uses a tracking tool (e.g., a cursor tracking application or a website tracking application) to determine one or more user interactions associated with the data resource. The one or more user interactions determined via the tracking tool can include one or more of a position of a mouse cursor, a time stamp, a time period of the mouse cursor hovering on a link of interest, a mouse click, a time period spent in an area of interest, and a time duration of a hover.

At operation 506, a processor determines degrees of user interactions with the one or more fields based on the one or more user interactions. For example, the processor can determine that the time duration of a hover for the product description field is longer than the time duration of a hover for the rest of the fields, indicating the user is more interested (e.g., a higher degree of user interactions) in viewing the product description field than the other fields when considering purchasing an item.

At operation 508, a processor generates the engagement data associated with the item based on the degrees of user interactions. In various examples, engagement metrics can also be generated based on the degrees of user interactions with the data resources. User engagement metrics can refer to measurements that help track metrics, such as page views, session duration, and user feedback. These metrics help provide a view that illustrates how engaged users are with the data resources described herein.

In various examples, the data management system can provide content generation recommendations based on various engagement metrics described herein. For example, an example engagement metric can indicate that users engage the best with product description fields that include, for example, less than 30 words. Based on such an engagement metric, the data management system can recommend a user (e.g., content creator of a product description page) to include 30 words or less when generating content for a product description field.

Though not illustrated, the method 500 can include an operation where a graphical user interface for managing data can be displayed (or caused to be displayed) by the hardware processor. For instance, the operation can cause a computing device to display the graphical user interface for managing data across a variety of data sources. This operation for displaying the graphical user interface can be separate from operations 502 through 508 or, alternatively, form part of one or more of operations 502 through 508.

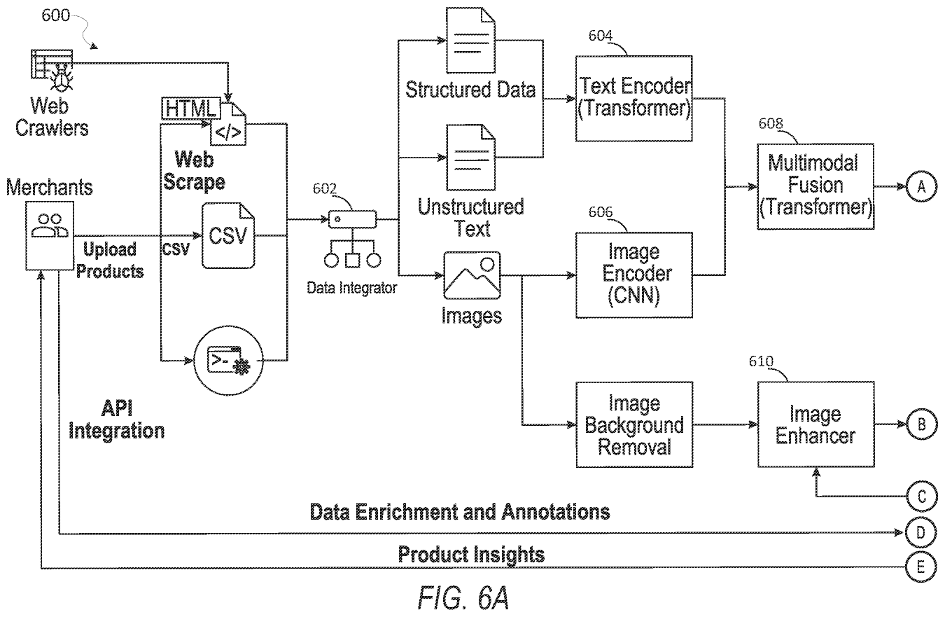

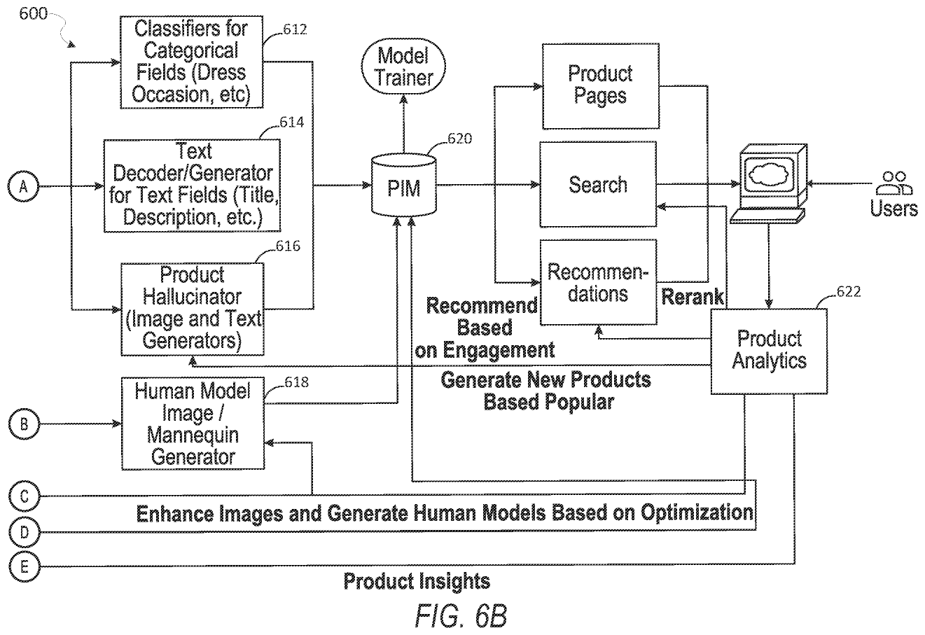

FIGS. 6A and 6B are block diagrams illustrating data flow 600 within an example data management system in a multimodal artificial intelligence system during operation, according to various examples. As illustrated in FIGS. 6A and 6B, a data integrator 602 (or data aggregator) integrates data from various data sources, including third-party data providers, and web sources, such as e-Commerce platforms, social media platforms, marketing channels, etc. The data integrator 602 may extract data from websites using web scraping tools (e.g., bots or web crawlers). In various examples, data integrator 602 may obtain data from users who upload one or more comma-separated values (CSV) files that include item information.

Text encoder 604 may include a component similar to the text encoding component 210 as described herein. Text encoder 604 can process structured and unstructured data using transformer-based NIL models.

Image encoder 606 may include a component similar to the image encoding component 220 as described herein. Image encoder 606 can process images using Convolutional Neural Network (CNN) based ML models.

Multimodal fusion 608 may include a component similar to the multimodal data integration component 230 as described herein. Multimodal fusion 608 can use transformer-based NIL models to integrate taxonomies across all product/service providers (e.g., brands), and generate taxonomies that are specific to particular product/service providers. Specifically, the text encoder 604 and the image encoder 606 each output vectors that feed into the multimodal fusion 608. The multimodal fusion 608 uses transformer-based Mt models to generate new sets of vectors, based on which the taxonomies are generated.

Image enhancer 610 may include a component similar to the image enhancing component 270 as described herein. Image enhancer 610 can enhance images, including without limitation, applying one or more filters (e.g., image processing filters) to images and removing the image backgrounds from images. For example, a person of ordinary skill in the art shall appreciate that digital image filtering may be performed by solutions such as convolution with kernels or filter array in the spatial domain, and/or masking specific frequency regions in the frequency (Fourier) domain.

Classifier for categorical fields 612 may include a component similar to the classifier generating component 240 as described herein. Classifier for categorical fields 612 can identify fields associated with items from data sources, determine attributes (e.g., first attribute) of the items based on content data and metadata associated with the fields, and match the determined attributes with attributes (e.g., second attribute) in an existing taxonomy. In response to (or based on) the matching, the classifier for categorical fields 612 is configured to generate classifiers (for all categorical fields) that represent categories of the item.

Text decoder/generator for text fields 614 may include a component similar to the text decoding component 250 as described herein. Text decoder/generator for text fields 614 can generate item titles and descriptions for the same or similar items based on the taxonomies as described herein.

Product Hallucinator 616 may include a component similar to the new item generating and managing component 260 as described herein. Product Hallucinator 616 can generate representations of new items based on the taxonomies. The new items are distinguishable from the items (e.g., products) offered for sale by a particular brand. The product Hallucinator 616 is further configured to generate test engagements based on the representations of the new items. A test engagement may be a UI element that displays an imagery representation of the new item and invites users to provide comments via text comments or clicks (e.g., like or dislike). Engagement data (e.g., in the form of reports, for example) may be generated based on the comments, which can be used for various downstream analysis.

Human model image/mannequin generator 618 may include a component similar to the model generating component 280 as described herein. Human model image/mannequin generator 618 can generate human models (or mannequins) based on images obtained from various data sources. Specifically, the human model image/mannequin generator 618 is configured to determine human characteristics that correspond to a specific geographical location and use ML models to apply the geographical-specific human characteristics to an existing image to alter the human model's appearance in the image.

PIM 620 may include a component that integrates all data processed by the components as described herein for downstream analysis and functions, including without limitation, building product pages, conducting marketing/product search and analysis, generating recommendations based on ranking, etc.

Product analytics 622 may include a component similar to the data quality score generating component as described herein. Product analytics 622 may generate one or more data quality scores for one or more items (e.g., the first item) of a brand in order to provide the merchant of the brand with product insights. Specifically, product analytics 622 may determine the degrees of completeness of one or more items based on the item data. Product analytics 622 may identify customer engagement data (or engagement data) associated with the same or similar items (e.g., the second item) and generate one or more data quality scores based on the degrees of completeness of one or more items (e.g., the first item) and the customer engagement data. In various examples, the customer engagement data may be associated with items of other brands and/or items dissimilar to the one or more items (e.g., the first item), based on which the one or more data quality scores are generated.

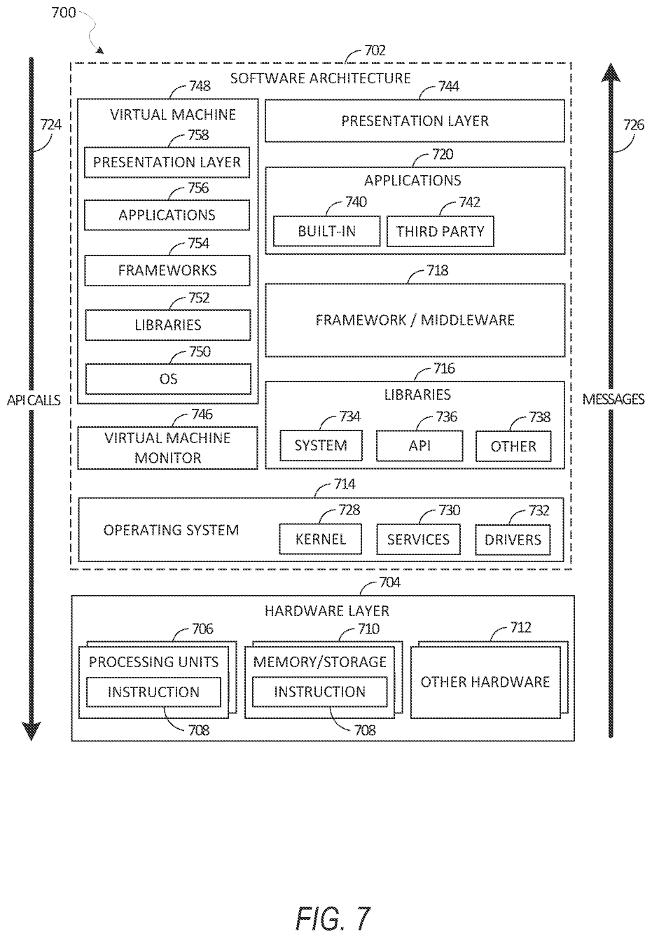

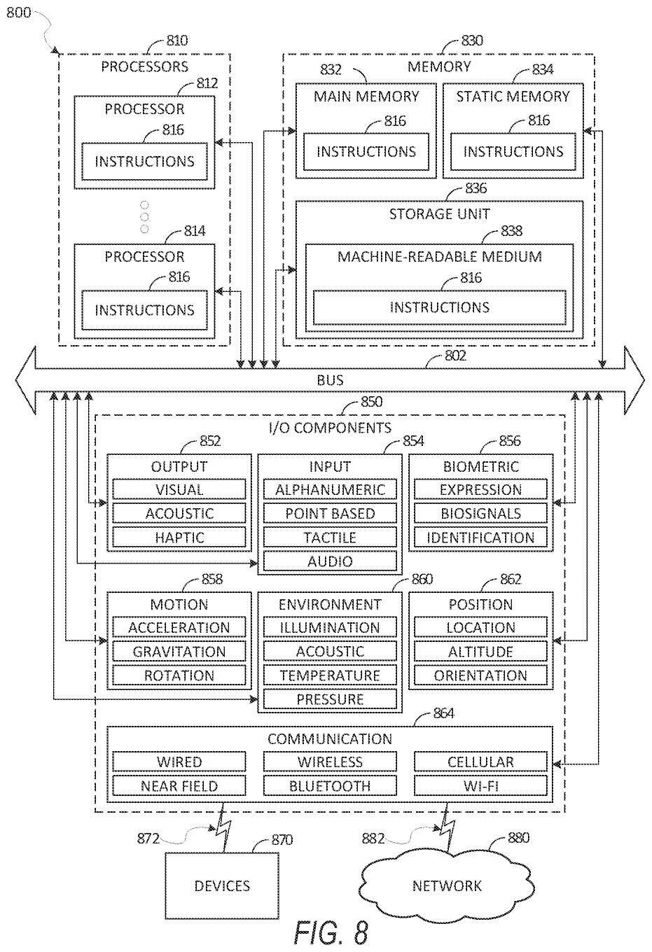

FIG. 7 is a block diagram illustrating an example of a software architecture 702 that may be installed on a machine, according to some examples. FIG. 7 is merely a non-limiting example of a software architecture, and it will be appreciated that many other architectures may be implemented to facilitate the functionality described herein. The software architecture 702 may be executing on hardware such as a machine 800 of FIG. 8 that includes, among other things, processors 810, memory 830, and input/output (I/O) components 850. A representative hardware layer 704 is illustrated and can represent, for example, the machine 800 of FIG. 8. The representative hardware layer 704 comprises one or more processing units 706 having associated executable instructions 708. The executable instructions 708 represent the executable instructions of the software architecture 702. The hardware layer 704 also includes memory or storage modules 710, which also have the executable instructions 708. The hardware layer 704 may also comprise other hardware 712, which represents any other hardware of the hardware layer 704, such as the other hardware illustrated as part of the machine 800.

In the example architecture of FIG. 7, the software architecture 702 may be conceptualized as a stack of layers, where each layer provides particular functionality. For example, the software architecture 702 may include layers such as an operating system 714, libraries 716, frameworks/middleware 718, applications 720, and a presentation layer 744. Operationally, the applications 720 or other components within the layers may invoke API calls 724 through the software stack and receive a response, returned values, and so forth (illustrated as messages 726) in response to the API calls 724. The layers illustrated are representative in nature, and not all software architectures have all layers. For example, some mobile or special-purpose operating systems may not provide a frameworks/middleware 718 layer, while others may provide such a layer. Other software architectures may include additional or different layers.

The operating system 714 may manage hardware resources and provide common services. The operating system 714 may include, for example, a kernel 728, services 730, and drivers 732. The kernel 728 may act as an abstraction layer between the hardware and the other software layers. For example, the kernel 728 may be responsible for memory management, processor management (e.g., scheduling), component management, networking, security settings, and so on. The services 730 may provide other common services for the other software layers. The drivers 1032 may be responsible for controlling or interfacing with the underlying hardware. For instance, the drivers 732 may include display drivers, camera drivers, Bluetooth® drivers, flash memory drivers, serial communication drivers (e.g., Universal Serial Bus (USB) drivers), drivers, audio drivers, power management drivers, and so forth depending on the hardware configuration.

The libraries 716 may provide a common infrastructure that may be utilized by the applications 720 and/or other components and/or layers. The libraries 716 typically provide functionality that allows other software modules to perform tasks in an easier fashion than by interfacing directly with the underlying operating system 714 functionality (e.g., kernel 728, services 730, or drivers 732). The libraries 716 may include system libraries 734 (e.g., C standard library) that may provide functions such as memory allocation functions, string manipulation functions, mathematic functions, and the like. In addition, the libraries 716 may include API libraries 736 such as media libraries (e.g., libraries to support presentation and manipulation of various media formats such as MPEG4, H.264, MP3, AAC, AMR, MG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 716 may also include a wide variety of other libraries 738 to provide many other APIs to the applications 720 and other software components/modules.

The frameworks 718 (also sometimes referred to as middleware) may provide a higher-level common infrastructure that may be utilized by the applications 720 or other software components/modules. For example, the frameworks 718 may provide various graphical user interface functions, high-level resource management, high-level location services, and so forth. The frameworks 718 may provide a broad spectrum of other APIs that may be utilized by the applications 720 and/or other software components/modules, some of which may be specific to a particular operating system or platform.

The applications 720 include built-in applications 740 and/or third-party applications 742. Examples of representative built-in applications 740 may include, but are not limited to, a home application, a contacts application, a browser application, a book reader application, a location application, a media application, a messaging application, or a game application.

The third-party applications 742 may include any of the built-in applications 740, as well as a broad assortment of other applications. In a specific example, the third-party applications 742 (e.g., an application developed using the Android™ or iOS™ software development kit (SDK) by an entity other than the vendor of the particular platform) may be mobile software running on a mobile operating system such as iOS™, Android™, or other mobile operating systems. In this example, the third-party applications 742 may invoke the API calls 724 provided by the mobile operating system such as the operating system 714 to facilitate functionality described herein.

The applications 720 may utilize built-in operating system functions (e.g., kernel 728, services 730, or drivers 732), libraries (e.g., system libraries 734, API libraries 736, and other libraries 738), or frameworks/′middleware 718 to create user interfaces to interact with users of the system. Alternatively, or additionally, in some systems, interactions with a user may occur through a presentation layer, such as the presentation layer 744. In these systems, the application/module “logic” can be separated from the aspects of the application/module that interact with the user.

Some software architectures utilize virtual machines. In the example of FIG. 7, this is illustrated by a virtual machine 748. The virtual machine 748 creates a software environment where applications/modules can execute as if they were executing on a hardware machine (e.g., the machine 800 of FIG. 8). The virtual machine 748 is hosted by a host operating system (e.g., the operating system 714) and typically, although not always, has a virtual machine monitor 746, which manages the operation of the virtual machine 748 as well as the interface with the host operating system (e.g., the operating system 714). A software architecture executes within the virtual machine 748, such as an operating system 750, libraries 752, frameworks/middleware 754, applications 756, or a presentation layer 758. These layers of software architecture executing within the virtual machine 748 can be the same as corresponding layers previously described or may be different.

FIG. 8 illustrates a diagrammatic representation of a machine 800 in the form of a computer system within which a set of instructions may be executed for causing the machine 800 to perform any one or more of the methodologies discussed herein, according to an example. Specifically, FIG. 8 shows a diagrammatic representation of the machine 800 in the example form of a computer system, within which instructions 816 (e.g., software, a program, an application, an applet, an app, or other executable code) for causing the machine 800 to perform any one or more of the methodologies discussed herein may be executed. For example, the instructions 816 may cause the machine 800 to execute the method 400 described above with respect to FIG. 4, and the method 500 described above with respect to FIG. 5. The instructions 816 transform the general, non-programmed machine 800 into a particular machine 800 programmed to carry out the described and illustrated functions in the manner described. In some examples, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer distributed) network environment. The machine 800 may comprise, but not be limited to, a server computer, a client computer, a personal computer (PC), a tablet computer, a laptop computer, a netbook, a personal digital assistant (PDA), an entertainment media system, a cellular telephone, a smart phone, a mobile device, or any machine capable of executing the instructions 816, sequentially or otherwise, that specify actions to be taken by the machine 800. Further, while only a single machine 800 is illustrated, the term “machine” shall also be taken to include a collection of machines 800 that individually or jointly execute the instructions 816 to perform any one or more of the methodologies discussed herein.

The machine 800 may include processors 810, memory 830, and I/O components 850, which may be configured to communicate with each other such as via a bus 802. In an example, the processors 810 (e.g., a hardware processor, such as a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 812 and a processor 814 that may execute the instructions 816. The term “processor” is intended to include multi-core processors that may comprise two or more independent processors (sometimes referred to as “cores”) that may execute instructions contemporaneously. Although FIG. 8 shows multiple processors 810, the machine 800 may include a single processor with a single core, a single processor with multiple cores (e.g., a multi-core processor), multiple processors with a single core, multiple processors with multiples cores, or any combination thereof.

The memory 830 may include a main memory 832, a static memory 834, and a storage unit 836 including machine-readable medium 838, each accessible to the processors 810 such as via the bus 802. The main memory 832, the static memory 834, and the storage unit 836 store the instructions 816 embodying any one or more of the methodologies or functions described herein. The instructions 816 may also reside, completely or partially, within the main memory 832, within the static memory 834, within the storage unit 836, within at least one of the processors 810 (e.g., within the processor's cache memory), or any suitable combination thereof, during execution thereof by the machine 800.

The I/O components 850 may include a wide variety of components to receive input, provide output, produce output, transmit information, exchange information, capture measurements, and so on. The specific 110 components 850 that are included in a particular machine will depend on the type of machine. For example, portable machines such as mobile phones will likely include a touch input device or other such input mechanisms, while a headless server machine will likely not include such a touch input device. It will be appreciated that the I/O components 850 may include many other components that are not shown in FIG. 8. The I/O components 850 are grouped according to functionality merely for simplifying the following discussion, and the grouping is in no way limiting. In various examples, the I/O components 850 may include output components 852 and input components 854. The output components 852 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 854 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further examples, the I/O components 850 may include biometric components 856, motion components 858, environmental components 860, or position components 862, among a wide array of other components. The motion components 858 may include acceleration sensor components (e.g., accelerometer), gravitation sensor components, rotation sensor components (e.g., gyroscope), and so forth. The environmental components 860 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 862 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 850 may include communication components 864 operable to couple the machine 800 to a network 880 or devices 870 via a coupling 882 and a coupling 872, respectively. For example, the communication components 864 may include a network interface component or another suitable device to interface with the network 880. In further examples, the communication components 864 may include wired communication components, wireless communication components, cellular communication components, near field communication (NFC) components, Bluetooth® components (e.g., Bluetooth® Low Energy), Wi-fi® components, and other communication components to provide communication via other modalities. The devices 870 may be another machine or any of a wide variety of peripheral devices (e.g., a peripheral device coupled via a USB).

Moreover, the communication components 864 may detect identifiers or include components operable to detect identifiers. For example, the communication components 864 may include radio frequency identification (RFID) tag reader components, NEC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra. Code, UCC RSS-2D bar code, and other optical codes), or acoustic detection components (e.g., microphones to identify tagged audio signals). In addition, a variety of information may be derived via the communication components 864, such as location via Internet Protocol (IP) geolocation, location via Wi-Fi® signal triangulation, location via detecting an NEC beacon signal that may indicate a particular location, and so forth.

Certain examples are described herein as including logic or a number of components, modules, elements, or mechanisms. Such modules can constitute either software modules (e.g., code embodied on a machine-readable medium or in a transmission signal) or hardware modules. A “hardware module” is a tangible unit capable of performing certain operations and can be configured or arranged in a certain physical manner. In various examples, one or more computer systems (e.g., a standalone computer system, a client computer system, or a server computer system) or one or more hardware modules of a computer system (e.g., a processor or a group of processors) are configured by software (e.g., an application or application portion) as a hardware module that operates to perform certain operations as described herein.

In various examples, a hardware module is implemented mechanically, electronically, or any suitable combination thereof. For example, a hardware module can include dedicated circuitry or logic that is permanently configured to perform certain operations. For example, a hardware module can be a special-purpose processor, such as a field-programmable gate array (FPGA) or an ASIC. A hardware module may also include programmable logic or circuitry that is temporarily configured by software to perform certain operations. For example, a hardware module can include software encompassed within a general-purpose processor or other programmable processor. It will be appreciated that the decision to implement a hardware module mechanically, in dedicated and permanently configured circuitry, or in temporarily configured circuitry (e.g., configured by software) can be driven by cost and time considerations.

Accordingly, the phrase “module” should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software can accordingly configure a particular processor or processors, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple hardware modules exist contemporaneously, communications can be achieved through signal transmission (e.g., over appropriate circuits and buses) between or among two or more of the hardware modules. In examples in which multiple hardware modules are configured or instantiated at different times, communications between or among such hardware modules may be achieved, for example, through the storage and retrieval of information in memory structures to which the multiple hardware modules have access. For example, one hardware module performs an operation and stores the output of that operation in a memory device to which it is communicatively coupled. A further hardware module can then, at a later time, access the memory device to retrieve and process the stored output. Hardware modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors constitute processor-implemented modules that operate to perform one or more operations or functions described herein. As used herein, “processor-implemented module” refers to a hardware module implemented using one or more processors.

Similarly, the methods described herein can be at least partially processor-implemented, with a particular processor or processors being an example of hardware. For example, at least some of the operations of a method can be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines 800 including processors 810), with these operations being accessible via a network (e.g., the Internet) and via one or more appropriate interfaces an API). In certain examples, for example, a client device may relay or operate in communication with cloud computing systems and may access circuit design information in a cloud environment.

The performance of certain of the operations may be distributed among the processors, not only residing within a single machine 800, but deployed across a number of machines 800. In some example examples, the processors 810 or processor-implemented modules are located in a single geographic location (e.g., within a home environment, an office environment, or a server farm). In other examples, the processors or processor-implemented modules are distributed across a number of geographic locations.

### Executable Instructions and Machine Storage Medium

The various memories (i.e., 830, 832, 834, and/or the memory of the processor(s) 810) and/or the storage unit 836 may store one or more sets of instructions 816 and data structures (e.g., software) embodying or utilized by any one or more of the methodologies or functions described herein. These instructions (e.g., the instructions 816), when executed by the processor(s) 810, cause various operations to implement the disclosed examples.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions 816 and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Transmission Medium

In various examples, one or more portions of the network 880 may be an ad hoc network, an intranet, an extranet, a virtual private network (VPN), a LAN, a wireless LAN (WLAN), a WAN, a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi®, network, another type of network, or a combination of two or more such networks. For example, the network 880 or a portion of the network 880 may include a wireless or cellular network, and the coupling 882 may be a Code Division Multiple Access (CDMA) connection, a Global System for Mobile communications (GSM) connection, or another type of cellular or wireless coupling. In this example, the coupling 882 may implement any of a variety of types of data transfer technology, such as Single Carrier Radio Transmission Technology (1×RTT), Evolution-Data Optimized (EVDO) technology, General Packet Radio Service (CPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LIE) standard, others defined by various standard-setting organizations, other long-range protocols, or other data transfer technology.

The instructions may be transmitted or received over the network using a transmission medium via a network interface device (e.g., a network interface component included in the communication components) and utilizing any one of a number of well-known transfer protocols (e.g., hypertext transfer protocol (HTTP)). Similarly, the instructions may be transmitted or received using a transmission medium via the coupling (e.g., a peer-to-peer coupling) to the devices 870. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions for execution by the machine, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal,

### Computer-Readable Medium

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals. For instance, an example described herein can be implemented using a non-transitory medium (e.g., a non-transitory computer-readable medium).

Throughout this specification, plural instances may implement resources, components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components.

As used herein, the term “or” may be construed in either an inclusive or exclusive sense. The terms “a” or “an” should be read as meaning “at least one,” “one or more,” or the like. The presence of broadening words and phrases such as “one or more,” “at least,” “but not limited to,” or other like phrases in some instances shall not be read to mean that the narrower case is intended or required in instances where such broadening phrases may be absent. Additionally, boundaries between various resources, operations, modules, engines, and data stores are somewhat arbitrary, and particular operations are illustrated in a context of specific illustrative configurations. Other allocations of functionality are envisioned and may fall within a scope of various examples. The specification and drawings are, accordingly, to be regarded in an illustrative rather than a restrictive sense.

It will be understood that changes and modifications may be made to the disclosed examples without departing from the scope of the present disclosure. These and other changes or modifications are intended to be included within the scope of the present disclosure.

What is claimed is:

1. A method comprising:
accessing item data that represents a first item;
identifying a plurality of fields and associated data content based on the item data;
using weighted scores to determine degrees of completeness of the plurality of fields based on the associated data content;
identifying engagement data associated with a second item that shares an item characteristic with the first item; and
using a machine learning model to generate a data quality score of the item data based on the degrees of completeness of the plurality of fields and the engagement data.

2. The method of claim 1, further comprising:
causing display of the data quality score on a user interface of a device.

3. The method of claim 1, wherein the plurality of fields comprises one or more of a text field, a video field, and an image field, and wherein the text field includes at least one of a color field, a title field, and a product description field.

4. The method of claim 1, wherein the engagement data comprises an engagement metric that indicates degrees of user interactions with one or more fields included in a web-based data resource associated with the second item.

5. The method of claim 4, wherein the web-based data resource associated with the second item comprises a product description webpage of the second item.

6. The method of claim 1, wherein the plurality of fields and associated data content are identified based on the item data using a natural language processing algorithm.

7. The method of claim 1, further comprising:
identifying a web-based data resource associated with the second item, the web-based data resource including one or more fields that describe the second item;
using a tracking tool to determine one or more user interactions associated with the web-based data resource;
determining degrees of user interactions with the one or more fields based on the one or more user interactions; and
generating the engagement data associated with the second item based on the degrees of user interactions with the one or more fields.

8. The method of claim 7, wherein the one or more user interactions associated with the web-based data resource comprise one or more of a position of a mouse cursor, a time stamp, a time period of the mouse cursor hovering on a link of interest, a mouse click, a time period spent in an area of interest, and a time duration of a hover.

9. A system comprising:
a memory storing instructions; and
one or more hardware processors communicatively coupled to the memory and configured by the instructions to perform operations comprising:
accessing item data that represents a first item;
identifying a plurality of fields and associated data content based on the item data;
using weighted scores to determine degrees of completeness of the plurality of fields based on the associated data content;
identifying engagement data associated with a second item that shares an item characteristic with the first item;
using a machine learning model to generate a data quality score of the item data based on the degrees of completeness of the plurality of fields and the engagement data; and
causing display of the data quality score on a user interface of a device.

10. The system of claim 9, wherein the operations further comprise:
causing display of the data quality score on a user interface of a device.

11. The system of claim 9, wherein the plurality of fields comprises one or more of a text field, a video field, and an image field, and wherein the text field includes at least one of a color field, a title field, and a product description field.

12. The system of claim 9, wherein the engagement data comprises an engagement metric that indicates degrees of user interactions with one or more fields included in a web-based data resource associated with the second item.

13. The system of claim 12, wherein the web-based data resource associated with the second item comprises a product description webpage of the second item.

14. The system of claim 9, wherein the plurality of fields and associated data content are identified based on the item data using a natural language processing algorithm.

15. The system of claim 9, wherein the operations further comprise:
identifying a web-based data resource associated with the second item, the web-based data resource including one or more fields that describe the second item;
using a cursor-tracking tool to determine one or more user interactions associated with the web-based data resource;
determining degrees of user interactions with the one or more fields based on the one or more user interactions; and
generating the engagement data associated with the second item based on the degrees of user interactions with the one or more fields.

16. The system of claim 15, wherein the one or more user interactions associated with the web-based data resource comprise one or more of a position of a mouse cursor, a time stamp, a time period of the mouse cursor hovering on a link of interest, a mouse click, a time period spent in an area of interest, and a time duration of a hover.

17. A non-transitory computer-readable medium comprising instructions that, when executed by a hardware processor of a device, cause the device to perform operations comprising:
accessing item data that represents a first item;
identifying a plurality of fields and associated data content based on the item data;
using weighted scores to determine degrees of completeness of the plurality of fields based on the associated data content;
identifying engagement data associated with a second item that shares an item characteristic with the first item;
using a machine learning model to generate a data quality score of the item data based on the degrees of completeness of the plurality of fields and the engagement data; and
causing display of the data quality score on a user interface of a device.

18. The non-transitory computer-readable medium of claim 17, wherein the operations further comprise:
causing display of the data quality score on a user interface of a device.

19. The non-transitory computer-readable medium of claim 17, wherein the operations further comprise:
identifying a web-based data resource associated with the second item, the web-based data resource including one or more fields that describe the second item;
using a cursor-tracking tool to determine one or more user interactions associated with the web-based data resource;
determining degrees of user interactions with the one or more fields based on the one or more user interactions; and
generating the engagement data associated with the second item based on the degrees of user interactions with the one or more fields.

20. The non-transitory computer-readable medium of claim 19, wherein the one or more user interactions associated with the web-based data resource comprise one or more of a position of a mouse cursor, a time stamp, a time period of the mouse cursor hovering on a link of interest, a mouse click, a time period spent in an area of interest, and a time duration of a hover.
